(19) United States
(12) Patent Application Publication
(10) Pub. No.: US 2010/0085467 A1
(43) Pub. Date: Apr. 8, 2010

(54) IMAGE PICKUP DEVICE CAPABLE OF PROVIDING GPS COORDINATES OF SUBJECT TO BE SHOT AND METHOD FOR DETECTING GPS COORDINATES THEREOF

(75) Inventor: Chih-Chung CHEN, Chiayi City (TW)

Correspondence Address: STEVENS & SHOWALTER LLP, 7019 CORPORATE WAY, DAYTON, OH, 45459-4238, US

(73) Assignee: Altek Corporation, Hsinchu (TW)

(21) Appl. No.: 12/408,744

(22) Filed: Mar. 23, 2009

(30) Foreign Application Priority Data
Oct. 3, 2008 (TW) 097138263

(51) Int. Cl. H04N 5/232

(52) U.S. Cl. 348/345; 348/E05.045

(57) ABSTRACT

A image pickup device capable of providing GPS coordinates of a subject to be shot and a method for detecting GPS coordinates thereof are described. The method includes the following steps. A first longitude, a first latitude, and a first altitude of a location of a image pickup device are obtained. When the image pickup module is focused on the subject to be shot, a focusing distance from the image pickup module to the subject and an elevation angle formed between the image pickup device and a horizontal direction and a horizontal angle formed between the image pickup device and a true north direction are measured. A second longitude, a second latitude, and a second altitude of a location of the subject to be shot are calculated according to the first longitude, the first latitude, the first altitude, the focusing distance, the elevation angle, and the horizontal angle.

### CROSS-REFERENCE TO RELATED APPLICATIONS

This non-provisional application claims priority under 35 U.S.C. §119(a) on Patent Application No(s). 097138263 filed in Taiwan, R.O.C. on Oct. 3, 2008 the entire contents of which are hereby incorporated by reference.

### BACKGROUND OF THE INVENTION

1. Field of the Invention

The present invention relates to a method for detecting Global Positioning System (GPS) coordinates, and more particularly to an image pickup device capable of providing GPS coordinates of a subject to be shot and a method for detecting GPS coordinates of a subject to be shot.

2. Related Art

Global Positioning System (GPS) is a round orbit satellite navigation system for middle distances, which can provide accurate positioning, velocity measurement, and highly precise time standard for an overwhelming majority (98%) of areas on the surface of the earth. The GPS has been developed and maintained by the United States Department of Defense, which could satisfy the demands of military users at any place all over the world or within a near-earth space to continuously and accurately determine three-dimensional positions, three-dimensional motions and the time. The system consists of 24 GPS satellites in space, 1 master station, 3 data upload stations, and 5 monitoring stations, and a GPS receiver as a user terminal on the ground. The location and altitude of a user terminal on the earth can be quickly determined simply through at least 4 satellites in the system. The more satellites it can be connected to, the more precise the decoded position is.

Since the GPS has advantages of not being influenced by weather conditions, having a high global coverage (98%), and a mobile positioning feature, it has been widely applied to civilian applications such as navigation (for example, airplane navigation, ship navigation, and vehicle navigation) and positioning (for example, anti-theft for vehicles, positioning of mobile communication devices), in addition to the military use.

In recent years, many manufacturers have configured the GPS into digital cameras and video cameras, so that the photos or films are enabled to show the locations where photos or films are taken. Currently, the prevailing GPS photos are just taken by an image pickup device equipped with the GPS, which can automatically record the GPS coordinates when taking photos and thus allow the user to make personal travel logs.

However, photos taken by using an image pickup device equipped with the GPS can only show the location of the image pickup device to the user, but cannot show the more exactly location of the subject on the photos.

### SUMMARY OF THE INVENTION

Accordingly, the present invention is directed to an image pickup device capable of providing Global Positioning System (GPS) coordinates of a subject to be shot and a method for detecting GPS coordinates thereof, which can enable a user to get to know a location of the subject to be shot.

An image pickup device capable of providing GPS coordinates of a subject to be shot is provided in the present invention, which includes a GPS receiver, an image pickup module, an elevation meter, a north finder, and an operation unit.

The GPS receiver is used for obtaining a first longitude, a first latitude, and a first altitude. The image pickup module is used for focusing on a subject to be shot to obtain a focusing distance. The elevation meter is used for measuring an elevation angle formed between the image pickup device and a horizontal direction. The north finder is used for measuring a horizontal angle formed between the image pickup device and a true north direction. The operation unit is used for calculating a second longitude, a second latitude, and a second altitude of a location of the subject to be shot according to the first longitude, the first latitude, the first altitude, the focusing distance, the elevation angle, and the horizontal angle.

The image pickup device capable of providing GPS coordinates of a subject to be shot in the present invention further includes a display unit. The display unit is electrically connected to the operation unit, for displaying the second longitude, the second latitude, and the second altitude.

A method for detecting GPS coordinates of a subject to be shot is provided in the present invention, which is applicable to an image pickup device to obtain a location of a subject to be shot. The method for detecting GPS coordinates of a subject to be shot includes the following steps. Firstly, a first longitude, a first latitude, and a first altitude of a location of the image pickup device are obtained. Then, an image pickup module of the image pickup device is utilized to focuse on a subject to be shot and a focusing distance from the image pickup module to the subject to be shot is obtained. When the image pickup module is focused on the subject to be shot, an elevation angle formed between the image pickup device and a horizontal direction is measured. When the image pickup module is focused on the subject to be shot, a horizontal angle formed between the image pickup device and a true north direction is measured. Finally, a second longitude, a second latitude, and a second altitude of a location of the subject to be shot are calculated according to the first longitude, the first latitude, the first altitude, the focusing distance, the elevation angle, and the horizontal angle.

The step of calculating the second longitude, the second latitude, and the second altitude of the location of the subject to be shot includes the following steps. An altitude difference and a horizontal distance between the subject to be shot and the image pickup device are calculated according to the focusing distance and the elevation angle. A longitude difference and a latitude difference between the subject to be shot and the image pickup device are calculated according to the horizontal distance and the horizontal angle. The second longitude is obtained by adding the longitude difference to the first longitude. The second latitude is obtained by adding the latitude difference to the first latitude. The second altitude is obtained by adding the altitude difference to the first altitude.

The method for detecting GPS coordinates of a subject to be shot disclosed in the present invention further includes: displaying the second longitude, the second latitude, and the second altitude.

In the image pickup device capable of providing GPS coordinates of a subject to be shot and the method for detecting GPS coordinates thereof provided in the present invention, firstly, the location of the image pickup device is obtained by using a GPS configured in the image pickup device. Then, the focusing distance between the image pickup device and the subject to be shot is obtained by the image pickup module. Next, the elevation angle formed between the image pickup device and the horizontal direction and the horizontal angle formed between the image pickup device and the true north direction are obtained by the elevation meter and the north finder. Then, the longitude difference, the latitude difference, and the altitude difference between the subject to be shot and the image pickup device are calculated according to the focusing distance, the elevation angle, and the horizontal angle by using trigonometric functions. Afterwards, the second longitude, the second latitude, and the second altitude of the location of the subject to be shot are obtained by respectively adding the longitude difference, the latitude difference, and the altitude difference to the first longitude, the first latitude, and the first altitude of the location of the image pickup device. Finally, the second longitude, the second latitude, and the second altitude of the location of the subject to be shot are displayed on the display unit, so that the user can clearly see the location of the subject to be shot.

### BRIEF DESCRIPTION OF THE DRAWINGS

The present invention will become more fully understood from the detailed description given herein below for illustration only, and thus is not limitative of the present invention, and wherein:

FIG. 1 is a schematic view of an image pickup device capable of providing GPS coordinates of a subject to be shot according to the present invention;

FIG. 2 is a schematic view of an angle formed between an image pickup device focusing on a subject to be shot and a horizontal direction;

FIG. 3 is a schematic view of an angle formed between an image pickup device focusing on a subject to be shot and a true north direction;

FIG. 4 is a first flow chart of a method for detecting GPS coordinates of a subject to be shot according to a first embodiment of the present invention; and

FIG. 5 is a second flow chart of a method for detecting GPS coordinates of a subject to be shot according to a second embodiment of the present invention.

### DETAILED DESCRIPTION OF THE INVENTION

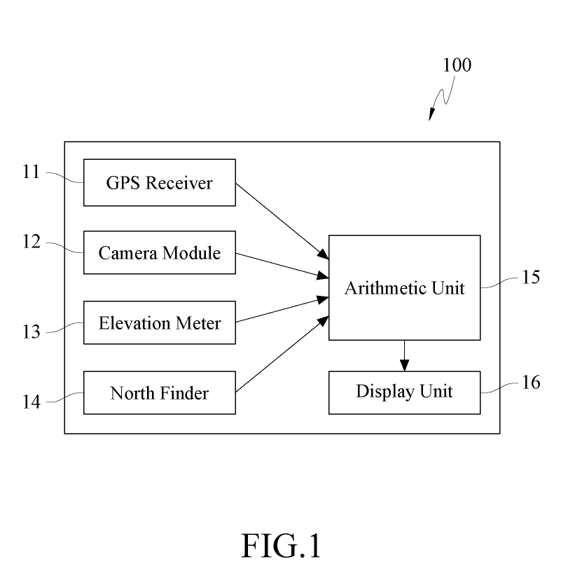

FIG. 1 is a schematic view of an image pickup device capable of providing GPS coordinates of a subject to be shot according to the present invention.

Referring to FIG. 1, an image pickup device 100 capable of providing GPS coordinates of a subject to be shot includes a GPS receiver 11, an image pickup module 12, an elevation meter 13, a north finder 14, an operation unit 15, and a display unit 16.

The GPS receiver 11 is used for obtaining a first longitude, a first latitude, and a first altitude.

The image pickup module 12 is used for focusing on a subject to be shot to obtain a focusing distance.

The elevation meter 13 is used for measuring an elevation angle formed between the image pickup device 100 capable of providing GPS coordinates of a subject to be shot and a horizontal direction.

The north finder 14 is used for measuring a horizontal angle formed between the image pickup device 100 capable of providing GPS coordinates of a subject to be shot and a true north direction. Definitely, the north finder 14 may also measure a horizontal angle formed between the image pickup device 100 capable of providing GPS coordinates of a subject to be shot and a true south direction.

The operation unit 15 is used for calculating a second longitude, a second latitude, and a second altitude of a location of the subject to be shot according to the first longitude, the first latitude, the first altitude, the focusing distance, the elevation angle, and the horizontal angle.

The display unit 16 is electrically connected to the operation unit 15 for displaying the second longitude, the second latitude, and the second altitude.

The image pickup module 12 may include a lens set, a stepping motor, an image-sensing module, and a processing unit. The stepping motor controls a pitch of the lens set to adjust the focal length, so as to focus on a subject to be shot. An image of the subject to be shot is projected onto the image-sensing element via the lens set. The processing unit is used to determine whether the image received by the image-sensing module is focused on the subject to be shot or not. The processing unit is further used to calculate a focusing distance between the image pickup device 100 capable of providing GPS coordinates of a subject to be shot and the subject to be shot by applying a combination of focal lengths of the individual lenses of the lens set.

The elevation meter 13 may be a gyroscope and the like.

The north finder 14 may be an instrument having a fixed direction under the effect of the geomagnetic field, such as a north indicator and a compass.

The operation unit 15 may be a microprocessor. The operation unit 15 may be a single microprocessor or may be formed by a plurality of microprocessors.

The display unit 16 may be a liquid crystal display (LCD), a light-emitting diode (LED) display, or an organic LED display, and the like.

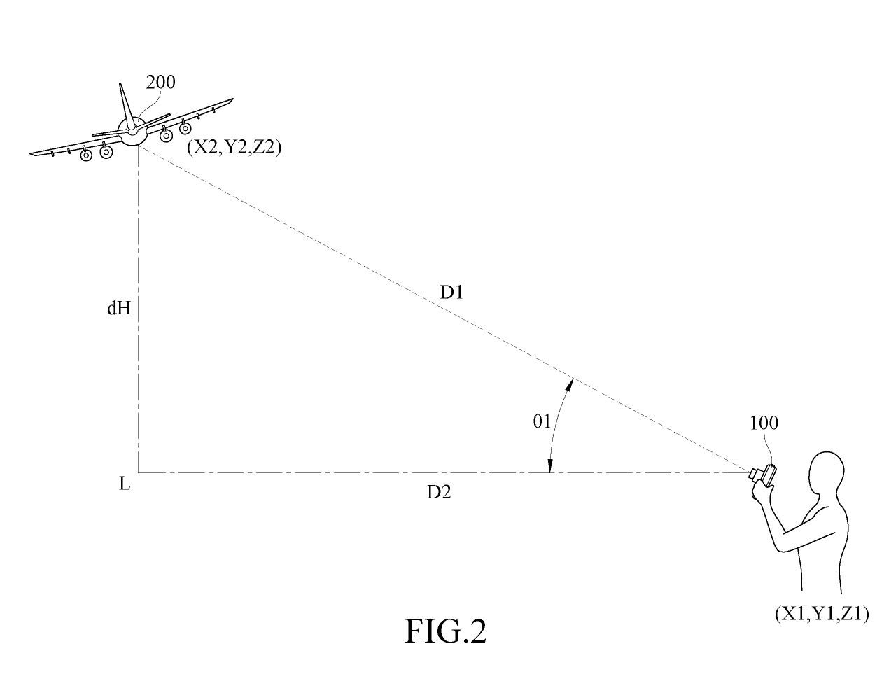

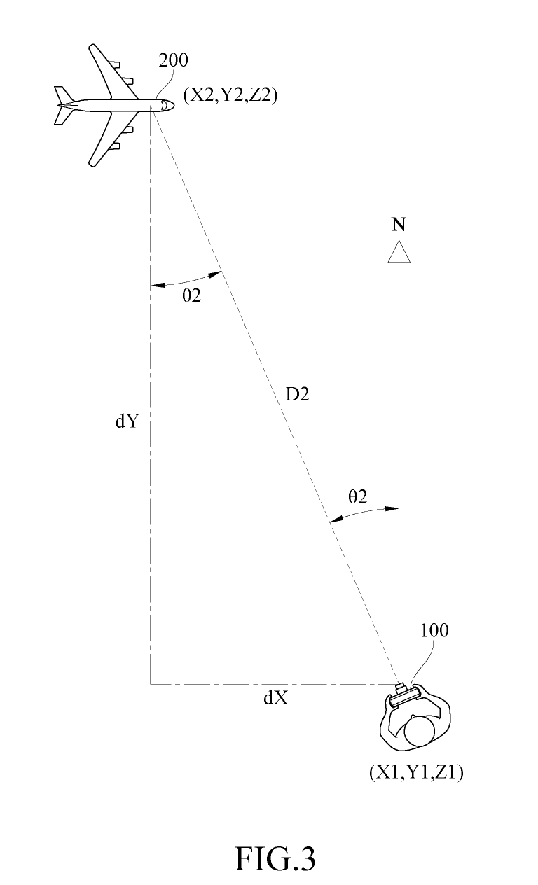

Description is given below with reference to FIGS. 2 and 3 together with FIG. 1.

Referring to FIG. 2, firstly, GPS coordinates (X1, Y1, Z1) of a location of the image pickup device 100 capable of providing GPS coordinates of a subject to be shot are obtained. X1 is a first longitude of the location of the image pickup device 100 capable of providing GPS coordinates of a subject to be shot. Y1 is a first latitude of the location of the image pickup device 100 capable of providing GPS coordinates of a subject to be shot. Z1 is a first altitude of the location of the image pickup device 100 capable of providing GPS coordinates of a subject to be shot.

The stepping motor is used to adjust the pitch of the lens set in the image pickup module 12, so that the image pickup module 12 focuses on a subject 200 to be shot (for example, an airplane, an automobile, or a mountain). The processing unit in the image pickup module 12 analyzes the received image of the subject 200 to be shot and determines whether the image pickup module 12 is focused on the subject 200 to be shot or not, so as to calculate a focusing distance D1 between the image pickup device 100 and the subject 200 to be shot through using a combination of focal lengths of individual lenses of the lens set.

When the image pickup module 12 is focused on the subject 200 to be shot, an elevation angle θ1 formed between the image pickup device 100 capable of providing GPS coordinates of a subject to be shot and a horizontal direction L is measured by the elevation meter 13 in the image pickup device 100. Equation a and Equation b are derived from the focusing distance D1 and the elevation angle Θ1 by using trigonometric functions.

D2=D1×Cos θ1 Equation a

dH=D1×Sin θ1 Equation b

D2 is a horizontal distance between the subject 200 to be shot and the image pickup device 100 capable of providing GPS coordinates of a subject to be shot. dH is an altitude difference between the subject 200 to be shot and the image pickup device 100.

Referring to FIG. 3, when the image pickup module 12 is focused on the subject 200 to be shot, a horizontal angle θ2 formed between the image pickup device 100 capable of providing GPS coordinates of a subject to be shot and a true north direction N is measured by the north finder 14 in the image pickup device 100. Equation c and Equation d are derived from Equation a, the horizontal distance D2, and the horizontal angle θ2 by using trigonometric functions.

dX=D2×Sin θ2=D1×Cos θ1×Sin θ2 Equation c

dY=D2×Cos θ2=D1×Cos θ1×Cos θ2 Equation d

dX is a longitude difference between the subject 200 to be shot and the image pickup device 100 capable of providing GPS coordinates of a subject to be shot. dY is a latitude difference between the subject 200 to be shot and the image pickup device 100 capable of providing GPS coordinates of a subject to be shot.

The longitude and the latitude are calculated on the basis of 0° East Longitude and 0° North Latitude. Since θ2 is calculated from the true north direction N, the longitude difference dX calculated by using trigonometric functions is opposite to the increasing direction of the first longitude X1. Therefore, the adding operation between the first longitude X1 and the longitude difference dX must be performed in a subtraction manner. Equation e, Equation f, and Equation g are derived from the first longitude X1, the first latitude Y1, the first altitude Z1, Equation b, Equation c, and Equation d.

X2=X1−dX=X1−D2×Sin θ2=X1−D1×Cos θ1×Sin θ2 Equation e

Y2=Y1+dY=Y1+D2×Cos θ2=Y1+D1×Cos θ1×Cos θ2 Equation f

Z2=Z1+dH=Z1+D1×Sin θ1 Equation g

X2 is a second longitude of a location of the subject 200 to be shot. Y2 is a second latitude of the location of the subject 200 to be shot. Z2 is a second altitude of the location of the subject 200 to be shot. X2, Y2, and Z2 obtained from the above calculations are the GPS coordinates (X2, Y2, Z2) of the location of the subject 200 to be shot.

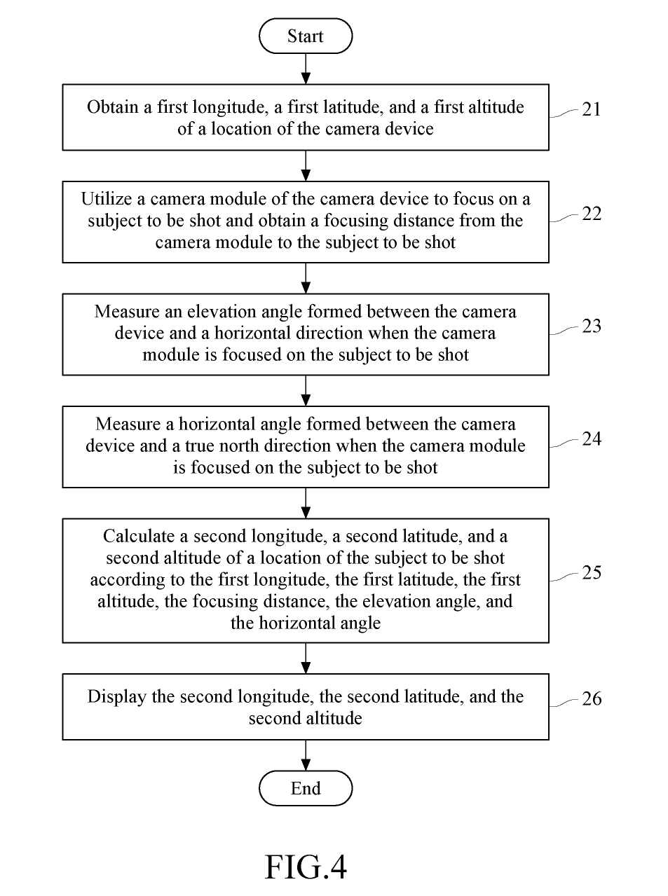

FIG. 4 is a flow chart of a method for detecting GPS coordinates of a subject to be shot according to a first embodiment of the present invention.

The method for detecting GPS coordinates of a subject to be shot is applied to an image pickup device to obtain a location of a subject to be shot. The method for detecting GPS coordinates of a subject to be shot includes the following steps. Firstly, a first longitude, a first latitude, and a first altitude of a location of the image pickup device are obtained (Step 21). Then, an image pickup module of the image pickup device is utilized to focused on a subject to be shot and a focusing distance from the image pickup module to the subject to be shot is obtained (Step 22). When the image pickup module is focused on the subject to be shot, an elevation angle formed between the image pickup device and a horizontal direction is measured (Step 23). When the image pickup module is focused on the subject to be shot, a horizontal angle formed between the image pickup device and a true north direction is measured (Step 24). Afterwards, a second longitude, a second latitude, and a second altitude of a location of the subject to be shot are calculated according to the first longitude, the first latitude, the first altitude, the focusing distance, the elevation angle, and the horizontal angle (Step 25). Finally, the second longitude, the second latitude, and the second altitude are displayed (Step 26).

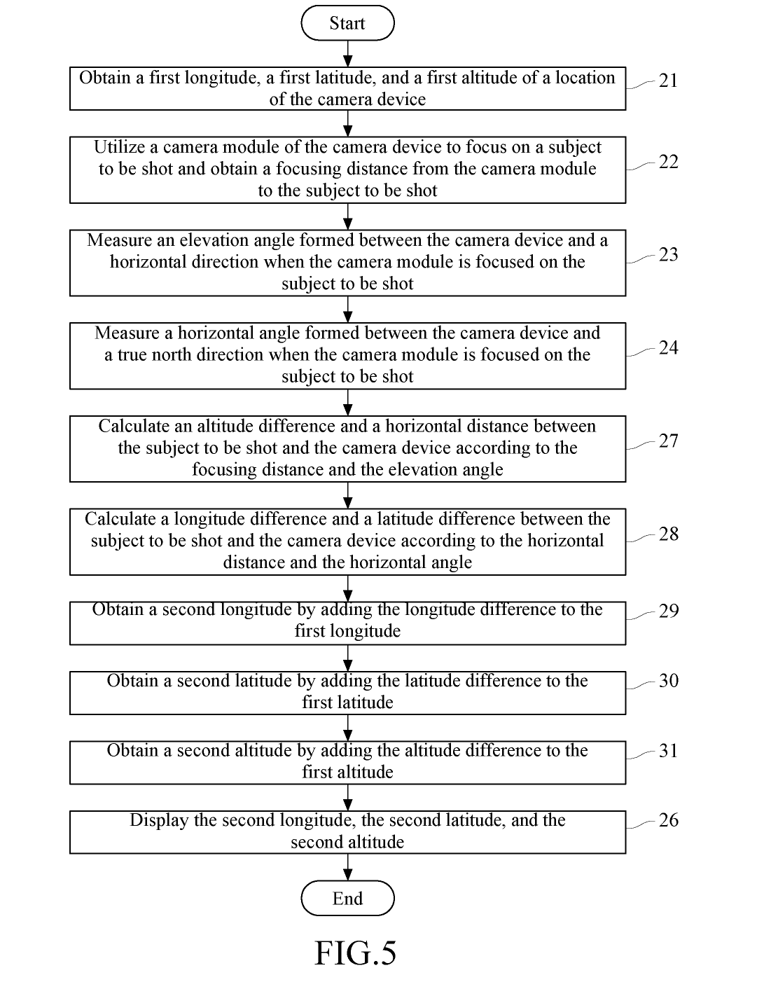

FIG. 5 is a flow chart of a method for detecting GPS coordinates of a subject to be shot according to a second embodiment of the present invention. Referring to FIG. 5, the flow chart of FIG. 5 is approximately the same as that of FIG. 4. Step 25 further includes the following steps. An altitude difference and a horizontal distance between the subject to be shot and the image pickup device are calculated according to the focusing distance and the elevation angle (Step 27). Afterwards, a longitude difference and a latitude difference between the subject to be shot and the image pickup device are calculated according to the horizontal distance and the horizontal angle (Step 28). Then, the second longitude is obtained by adding the longitude difference to the first longitude (Step 29). Then, the second latitude is obtained by adding the latitude difference to the first latitude (Step 30). Then, the second altitude is obtained by adding the altitude difference to the first altitude (Step 31).

In the image pickup device capable of providing GPS coordinates of a subject to be shot and the method for detecting GPS coordinates thereof provided in the present invention, firstly, the location of the image pickup device is obtained by using a GPS configured in the image pickup device. Then, the focusing distance between the image pickup device and the subject to be shot is obtained by the image pickup module. Next, the elevation angle formed between the image pickup device and the horizontal direction and the horizontal angle formed between the image pickup device and the true north direction are obtained by the elevation meter and the north finder. Then, the longitude difference, the latitude difference, and the altitude difference between the subject to be shot and the image pickup device are calculated according to the focusing distance, the elevation angle, and the horizontal angle by using trigonometric functions. Afterwards, the second longitude, the second latitude, and the second altitude of the location of the subject 200 to be shot are obtained by respectively adding the longitude difference, the latitude difference, and the altitude difference to the first longitude, the first latitude, and the first altitude of the location of the image pickup device. Finally, the second longitude, the second latitude, and the second altitude of the location of the subject to be shot are displayed on the display unit, so that the user can clearly see the location of the subject to be shot.

What is claimed is:

1. A image pickup device capable of providing Global Positioning System (GPS) coordinates of a subject to be shot, comprising:
a GPS receiver, for obtaining a first longitude, a first latitude, and a first altitude;
a image pickup module, for focusing on a subject to be shot to obtain a focusing distance;
an elevation meter, for measuring an elevation angle formed between the image pickup device and a horizontal direction;
a north finder, for measuring a horizontal angle formed between the image pickup device and a true north direction; and
an operation unit, for calculating a second longitude, a second latitude, and a second altitude of a location of the subject to be shot according to the first longitude, the first latitude, the first altitude, the focusing distance, the elevation angle, and the horizontal angle.

2. The image pickup device capable of providing GPS coordinates of a subject to be shot according to claim 1, further comprising:
a display unit, electrically connected to the operation unit, for displaying the second longitude, the second latitude, and the second altitude.

3. A method for detecting Global Positioning System (GPS) coordinates of a subject to be shot, applicable to a image pickup device to obtain a location of a subject to be shot, comprising:
obtaining a first longitude, a first latitude, and a first altitude of a location of the image pickup device;
utilizing an image pickup module of the image pickup device to focus on a subject to be shot and obtaining a focusing distance from the image pickup module to the subject to be shot;
measuring an elevation angle formed between the image pickup device and a horizontal direction when the image pickup module is focused on the subject to be shot;
measuring a horizontal angle formed between the image pickup device and a true north direction when the image pickup module is focused on the subject to be shot; and
calculating a second longitude, a second latitude, and a second altitude of a location of the subject to be shot according to the first longitude, the first latitude, the first altitude, the focusing distance, the elevation angle, and the horizontal angle.

4. The method for detecting GPS coordinates of a subject to be shot according to claim 3, wherein the step of calculating the second longitude, the second latitude, and the second altitude of the location of the subject to be shot comprises:
calculating an altitude difference and a horizontal distance between the subject to be shot and the image pickup device according to the focusing distance and the elevation angle;
calculating a longitude difference and a latitude difference between the subject to be shot and the image pickup device according to the horizontal distance and the horizontal angle;
obtaining the second longitude by adding the longitude difference to the first longitude;
obtaining the second latitude by adding the latitude difference to the first latitude; and
obtaining the second altitude by adding the altitude difference to the first altitude.

5. The method for detecting GPS coordinates of a subject to be shot according to claim 3, further comprising:
displaying the second longitude, the second latitude, and the second altitude.
